(19) United States
(12) Patent Application Publication
(10) Pub. No.: US 2025/0246791 A1
(43) Pub. Date: Jul. 31, 2025

(54) HIGH-FREQUENCY ASSEMBLY FOR RADAR SENSORS

(71) Applicant: Robert Bosch GmbH, Stuttgart (DE)

(72) Inventors: Andreas Kugler, Alfdorf (DE); Armin Himmelstoss, Weissach Im Tal (DE)

(21) Appl. No.: 18/612,134

(22) PCT Filed: Nov. 14, 2022
(86) PCT No.: PCT/EP2022/081740

§ 371 Date: Mar. 21, 2024

(30) Foreign Application Priority Data
Dec. 17, 2021 (DE) 10 2021 214 637.6

(51) Int. Cl. H01P 5/107; H01P 5/02

(52) U.S. Cl. CPC H01P 5/107; H01P 5/024

(57) ABSTRACT

A high-frequency assembly for radar sensors. The assembly includes a high-frequency component in the form of a package, which contains a semiconductor chip and, on its surface, has connections for contacting the semiconductor chip; a system board with conductor paths for controlling the package; and a waveguide structure for transmitting microwave signals to or from the package. The package is arranged on an adapter card, which itself is arranged on the system board and connects the package to the conductor paths of the system board, and the adapter card forms a microwave conductor structure, which is directly coupled to the waveguide structure.

### FIELD

The present invention relates to a high-frequency assembly for radar sensors, including a high-frequency component in the form of a package, which contains a semiconductor chip and, on its surface, has connections for contacting the semiconductor chip; a system board with conductor paths for controlling the package; and a waveguide structure for transmitting microwave signals to or from the package.

In particular, the present invention relates to a high-frequency assembly for radar sensors in motor vehicles.

### BACKGROUND INFORMATION

In the radar sensors previously used in motor vehicles, the microwave conductor structure is mostly formed by strip lines on a high-frequency-capable board, and the package of the high-frequency component is mounted on the surface of the board. Increasingly, however, microwave conductor structures in the form of waveguides are also being used, which generally make low-loss transmission of the microwave power possible.

### SUMMARY

An object of the present invention is to provide a high-frequency assembly that can be produced cost-effectively and makes low-loss transmission of the microwave power possible.

According to the present invention, this object may be achieved in that the package is arranged on an adapter card, which itself is arranged on the system board and connects the package to the conductor paths of the system board, and in that the adapter card forms a microwave conductor structure, which directly couples to the waveguide structure.

In the high-frequency assembly according to the present invention, only the adapter card needs to consist of high-frequency-capable material, while the system board does not need to be high-frequency-capable. This makes cost-effective manufacture of the assembly possible. The package may be a commercially available package that can be mounted on the adapter card with known mounting and contacting techniques like the packages were previously mounted on the system board. The microwave conductor structure integrated in the adapter card makes low-loss coupling of the package to the waveguide structure possible.

Advantageous embodiments of the present invention are disclosed herein.

According to an example embodiment of the present invention, the microwave conductor structure in the adapter card may optionally be formed by strip lines or by waveguide structures. If the adapter card comprises waveguide structures, the latter may, for example, be designed in SiW (substrate-integrated waveguide) technology.

The package can, for example, be an eWLB (embedded wafer-level ball grid array) package or a WLP (wafer-level packaging) module.

Exemplary embodiments of the present invention are explained in more detail below with reference to the figures.

### BRIEF DESCRIPTION OF THE DRAWINGS

FIG. 1 shows a schematic section through a high-frequency assembly in accordance with an exemplary embodiment of the present invention.

FIG. 2 shows a perspective transparent representation of a waveguide structure in an adapter card, according to an example embodiment of the present invention.

FIGS. 3 to 9 show schematic sectional views of high-frequency assemblies according to further embodiments of the present invention.

### DETAILED DESCRIPTION OF EXAMPLE EMBODIMENTS

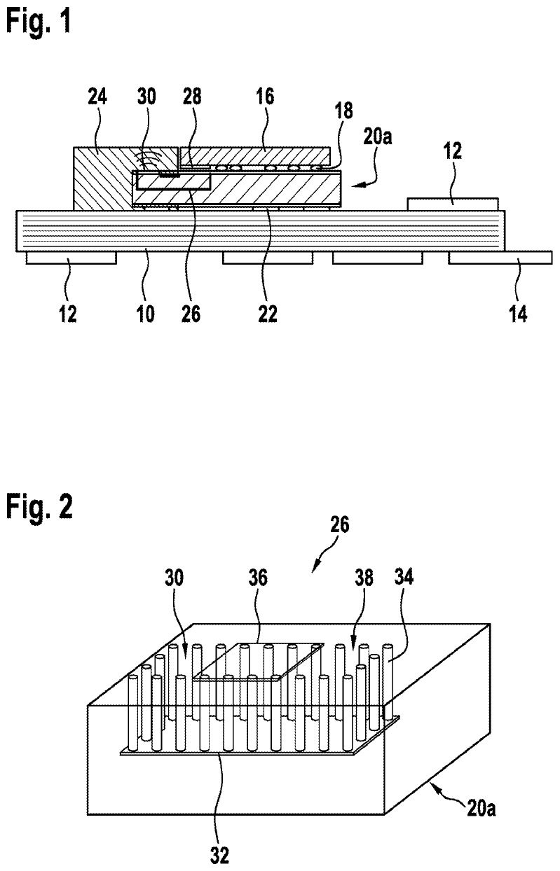

In FIG. 1, a high-frequency assembly according to the present invention is shown in a schematic section. The assembly comprises a system board 10, which is formed in a conventional manner by an alternating sequence of conductive and non-conductive layers, wherein the non-conductive layers do however not have to consist of a high-frequency-capable material. In the example shown, the system board 10 is equipped on both sides with electronic assemblies 12, plug contacts 14 and the like. A high-frequency component in the form of a package 16, e.g., an eWLB package, the electrical connections of which are formed by a grid-shaped arrangement of solder balls 18, is arranged on the side forming the top side of the system board 10 in FIG. 1. Unlike in conventional high-frequency assemblies, the package 16 here is however not mounted directly on the top side of the system board 10 but on an adapter card 20a, which itself is mounted on the top side of system board 10.

The conductive layers of the system board 10 each form a number of conductor paths, which are connected by through-connections to conductor paths in other layers so that a network is created that connects the electronic assemblies 12 and the plug contacts 14 to one another and also to the adapter card 20a. Similarly to the system board 10, the adapter card 20a also comprises an alternating sequence of conductive and non-conductive layers, which form a network of conductor paths connected via through-connections, through which network the solder balls 18 of the package 16 are electrically connected to contacts 22 on the bottom side of the adapter card and then, via said contacts, to the conductor paths of the system board 10.

The package 16 contains a semiconductor chip, e.g., an MMIC chip (monolithic microwave integrated circuit), which serves to generate and/or process microwave signals.

In FIG. 1, a waveguide structure 24 is arranged adjacent to an end of the adapter card 20a and of the package 16 on the top side of the system board 10, which waveguide structure either forms an antenna arrangement or serves to forward the microwave signals generated in the package 16 to one or more antennas and/or to forward the signals received from the antennas to the MMIC chip. The adapter card 20 consists of high-frequency-capable material and internally has a microwave conductor structure 26, via which the MMIC chip is coupled to the waveguide structure 24.

In the example shown in FIG. 1, the package 16 has a coupling point 28 for the electromagnetic radiation coupling of the MMIC to an end of the waveguide structure 26. At the opposite end, the microwave conductor structure 26 forms a window 30, which opens upward into the waveguide structure 24 so that the microwave signals can be coupled into or decoupled from the waveguide structure 24. Numerous embodiments are known for the design of the waveguide structure 24, which is why the details of the waveguide structure are not shown and described in more detail here.

The microwave conductor structure 26 may, for example, be a waveguide structure in SiW technology. The general design of such a waveguide structure 26 is illustrated in FIG. 2. One of the electrically conductive layers of the adapter card 20a forms a rectangular, electrically conductive lower termination surface 32 of the waveguide structure, which here forms the microwave conductor structure 26. The space above this termination surface 32 is “fenced in” by through-connections 34. The distances between the adjacent through-connections 34 are smaller than the wavelength of the microwaves to be transmitted so that the through-connections 34 together act like the conductive walls of a waveguide. A conductive layer on the top side of the adapter card 20a forms an upper termination surface 36 of the waveguide structure. The upper termination surface 36 also has a rectangular floor plan but is shorter than the lower termination surface 32, so that, at the opposite ends of the waveguide, the aforementioned window 30 for coupling to the waveguide structure 24 is formed on the one hand and a further window 38 that is opposite the coupling point 28 (FIG. 1) is formed on the other hand. It is understood that, in the space enclosed by the through-connections 34, all electrically conductive layers of the adapter card 20 located between the termination surfaces 32 and 36 are removed or recessed so that they do not hinder the propagation of the microwaves.

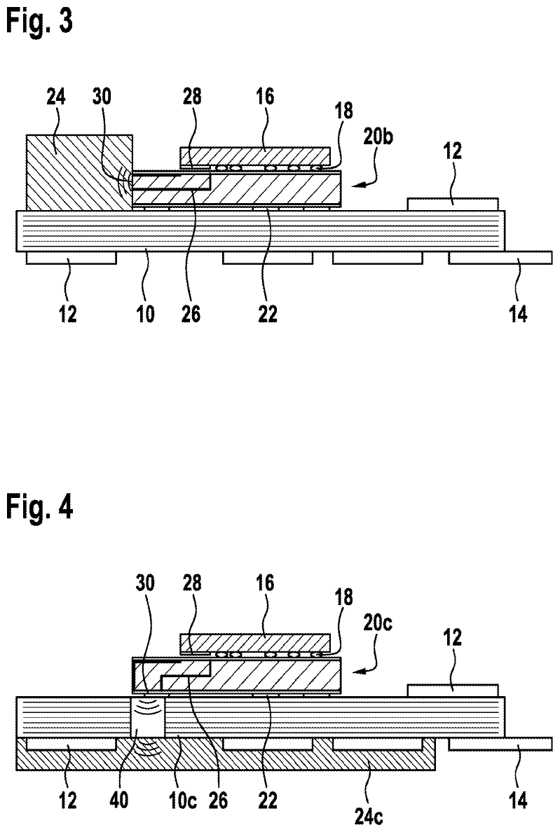

FIG. 3 shows, as a further exemplary embodiment, a high-frequency assembly with an adapter card 20b, which differs from the adapter card 20a of FIG. 1 in that the window 30 for coupling to the waveguide assembly 24 is not on the top side of the adapter card but in a face side of the adapter card.

FIG. 4 shows an exemplary embodiment in which a waveguide structure 24c is located on the bottom side of a system board 10c. The system board 10c differs from the system board 10 in the above-described exemplary embodiments in that, at one location, it has an aperture 40 that extends from the top side through to the bottom side and is not interrupted by electrically conductive layers. This exemplary embodiment uses an adapter card 20c, which differs from the above-described adapter cards in that the window 30 opens toward the bottom side, namely toward the aperture 40. In this case, the microwave conductor structure 26 has an L-shaped configuration with a horizontal branch extending from the coupling point 28 to the position of the aperture and a vertical branch connecting the horizontal branch to the aperture 40. The microwave conductor structure 26 this example may also be a waveguide structure in SiW technology. The aperture 40 may be an air-filled bore or milled-out portion of the board but may optionally also be filled with a dielectric. The vertical walls of the aperture 40 may optionally be metalized or fenced in by through-connections or be formed by a metalized plug-in.

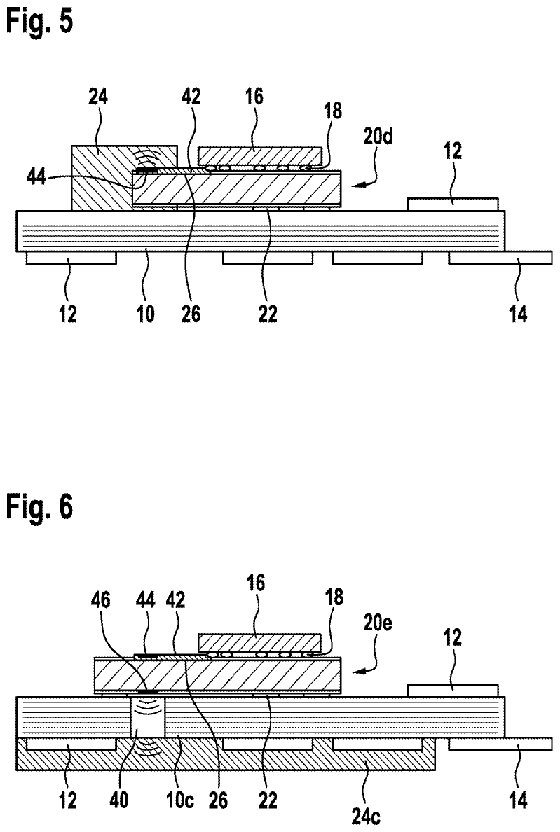

FIG. 5 shows an exemplary embodiment in which the adapter card 20a shown in FIG. 1 is replaced by an adapter card 20d. The difference is that the microwave conductor structure 26 has a strip conductor 42 instead of the waveguide structure. In this case, the decoupling of the microwave signal from the MMIC takes place by galvanic coupling between the strip line 42 and one or more of the solder balls 18 of the package 16. The window 30 of FIG. 6 is replaced by a patch 44, which couples the signal, transmitted via the strip line 42, into the waveguide structure 24.

The strip line 42 may optionally be laid on the top side of or inside the conductor card 20d and may be configured in any known manner, for example as a shielded or unshielded microstrip line, as a triplate line, suspended substrate line, microstrip line with ground slot, a plurality of coupled microstrip lines, coplanar strip line, coplanar line, slot line or shielded slot line, or fin line.

FIG. 6 shows an exemplary embodiment which combines the waveguide structure 24c shown in FIG. 4 and the system board 10c with an adapter card 20e, in which the microwave conductor structure 26 has a strip line 42 and a patch 44 similarly to FIG. 5. In this case, however, there is a further patch 46 on the bottom side of the adapter card, which further patch together with the patch 44 forms a resonator for decoupling the microwave power into the aperture 40. In the space between the two patches 44, 46 of the adapter card 20, all conductive layers are removed or recessed so that an uninterrupted resonance chamber is formed.

For the aperture 40 in this embodiment, all configurations mentioned above in connection with FIG. 4 are also possible.

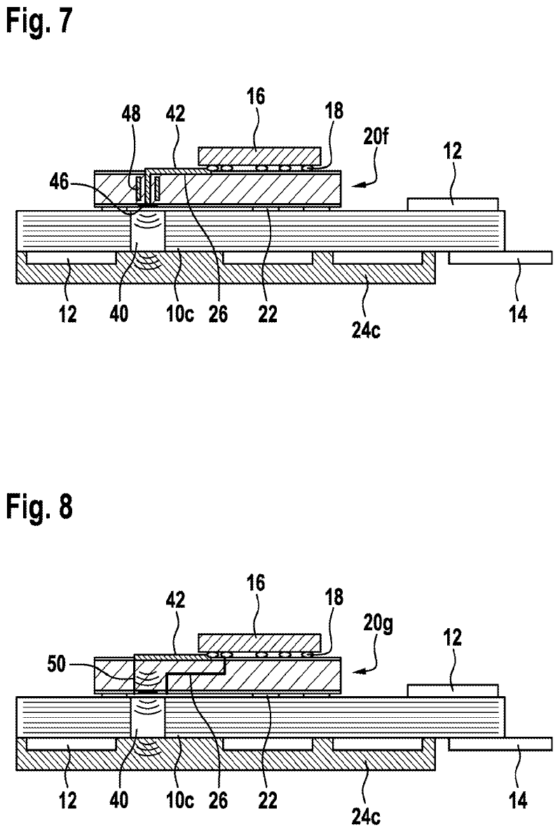

FIG. 7 shows an exemplary embodiment which differs from the exemplary embodiment of FIG. 6 in that, instead of the adapter card 20e, an adapter card 20f is provided, which comprises a coaxial line 48, instead of a resonator, for transmitting the microwave signal between the strip line 42 and the patch 46.

FIG. 8 shows an exemplary embodiment which differs from the exemplary embodiment of FIG. 7 in that, instead of the adapter card 20f, an adapter card 20g is provided, which comprises a waveguide structure 50, e.g., a SiW-SiW waveguide transition, which is, for example, designed according to the principle illustrated in FIG. 2, instead of the coaxial line 48.

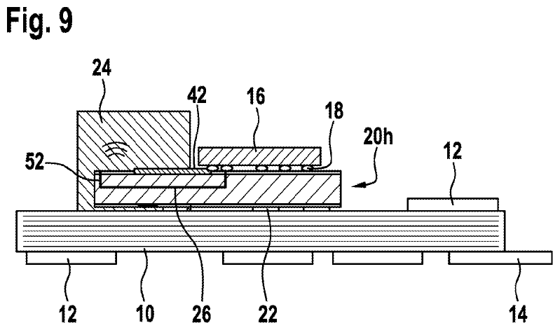

FIG. 9 shows an exemplary embodiment which differs from the exemplary embodiment of FIG. 3 in that the adapter card 20a is replaced by an adapter card 20h, in which the microwave conductor structure 26 comprises the strip line 42, which is galvanically coupled to one of the solder balls 18, and a waveguide structure 52 (SiW-SiW waveguide transition), which forms an upward opening window for coupling to the waveguide structure 24.

1-10. (canceled)

11. A high-frequency assembly for radar sensors, comprising:
a high-frequency component in the form of a package, the package containing a semiconductor chip and, on a surface of the package, has connections for contacting the semiconductor chip;
a system board with conductor paths for controlling the package; and
a waveguide structure configured to transmit microwave signals to or from the package;
wherein the package is arranged on an adapter card, the adapter card being arranged on the system board and connects the package to the conductor paths of the system board, and the adapter card forms a microwave conductor structure, which is directly coupled to the waveguide structure.

12. The high-frequency assembly according to claim 11, wherein the microwave conductor structure includes a waveguide structure.

13. The high-frequency assembly according to claim 12, wherein the waveguide structure of the adapter card is configured in SiW technology.

14. The high-frequency assembly according to claim 11, wherein the microwave conductor structure includes a strip line.

15. The high-frequency assembly according to claim 14, wherein the strip line couples to the waveguide structure via a patch.

16. The high-frequency assembly according to claim 14, wherein the strip line couples to the waveguide assembly via a resonator.

17. The high-frequency assembly according to claim 14, wherein the strip line couples to the waveguide structure via a right-angled coaxial line extending through the adapter card.

18. The high-frequency assembly according to claim 11, wherein the adapter card and the waveguide structure are arranged on opposite sides of the system board, and the system board has an aperture transparent to microwave radiation.

19. The high-frequency assembly according to claim 11, wherein the package is coupled to the microwave conductor structure by radiation coupling.

20. The high-frequency assembly according to claim 11, wherein the package is galvanically coupled to the high-frequency conductor structure.
